(19) United States
(12) Patent Application Publication
(10) Pub. No.: US 2008/0176433 A1
(43) Pub. Date: Jul. 24, 2008

(54) CONNECTOR ADAPTER

(75) Inventor: ZHENG-HENG SUN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/739,113

(22) Filed: Apr. 24, 2007

(30) Foreign Application Priority Data
Jan. 22, 2007 (CN) 200710200094.7

(51) Int. Cl. H01R 29/00

(52) U.S. Cl. 439/188

(57) ABSTRACT

A connector adapter includes a base. A switch and a plurality of pins are arranged on the base, and a plurality of sockets is defined in the base corresponding to the pins. The pins are correspondingly connected to the sockets via the switch. The switch controls the electrical connections between the pins and the sockets.

### BACKGROUND OF THE INVENTION

1. Field of the Invention

The present invention relates to adapters, and particularly to a connector adapter which can connect two corresponding connectors.

2. Description of Related Art

Generally speaking, most computers and servers have many kinds of connectors arranged thereon. When using or testing these computers, users often switch connections between two corresponding connectors frequently, which will shorten the lifespan of the connectors.

What is desired, therefore, is to provide a connector adapter which can connect two corresponding connectors and conveniently switch connections therebetween.

### SUMMARY OF THE INVENTION

An exemplary connector adapter includes a base. A switch and a plurality of pins are arranged on the base, and a plurality of sockets is defined in the base corresponding to the pins. The pins are correspondingly connected to the sockets via the switch. The switch controls the electrical connections between the pins and the sockets.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric view of a connector adapter in accordance with a first embodiment of the present invention;

FIG. 2 is an exploded, isometric view of FIG. 1 together with two corresponding connectors;

FIG. 3 is an assembled view of FIG. 2;

FIG. 4 is an isometric view of a connector adapter in accordance with a second embodiment of the present invention; and

FIG. 5 is an isometric view of a connector adapter in accordance with a third embodiment of the present invention.

### DETAILED DESCRIPTION OF THE INVENTION

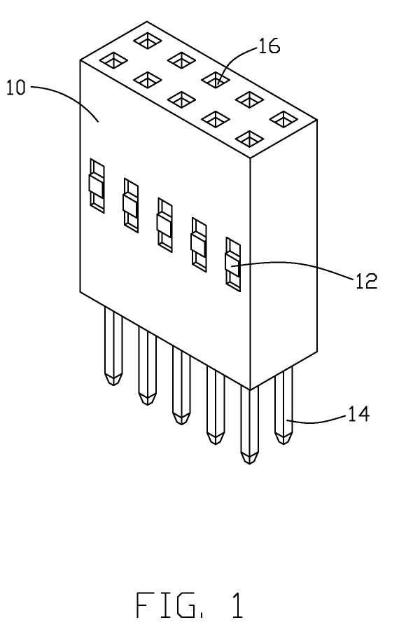

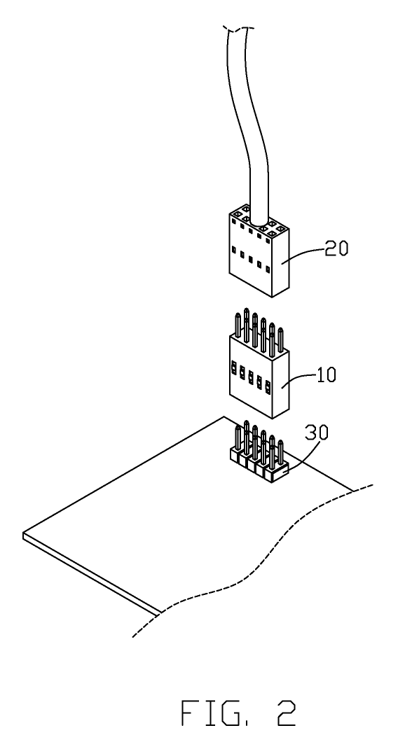

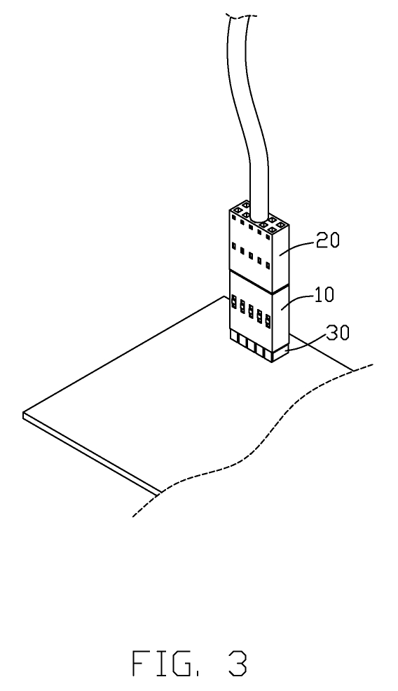

Referring to FIGS. 1 to 3, a connector adapter in accordance with a first embodiment of the present invention is provided for connecting two corresponding connectors. The connector adapter includes a base 10. A plurality of pins 14 extends out of an end of the base 10. A plurality of sockets 16 is defined in an opposite end of the base 10. A switch including a plurality of sub-switches 12 is arranged between the pins 14 and the sockets 16, and exposed from side surfaces of the base 10. The pins 14 are correspondingly connected to the sockets 16 via the sub-switches 12.

The pins 14 are adapted for connecting to an external electrical connector 20. The sockets 16 are adapted for connecting to a printed circuit board (PCB) electrical connector 30 such as a power connector. The external electrical connector 20 can directly connect with the PCB electrical connector 30. The number and shape of pins 14 are the same as the pins of the PCB electrical connector 30, and can directly connect with the external electrical connector 20. The number and shape of sockets 16 is the same as the sockets of the external electrical connector 20, and can directly connect with the PCB electrical connector 30. In this embodiment, there are ten pins 14 and ten sockets 16, the sub-switches 12 are slide switches. Each sub-switch 12 controls an electrical connection between one of the pins 14 and its corresponding socket 16.

When using the connector adapter, the sockets 16 are connected to the PCB electrical connector 30 correspondingly, then the external electrical connector 20 is connected to the pins 14 correspondingly. Thereby, the external electrical connector 20 is connected to the PCB electrical connector 30 via the connector adapter 10, and the connector adapter 10 can control electrical connections between the external electrical connector 20 and the PCB electrical connector 30 by the sub-switches 12.

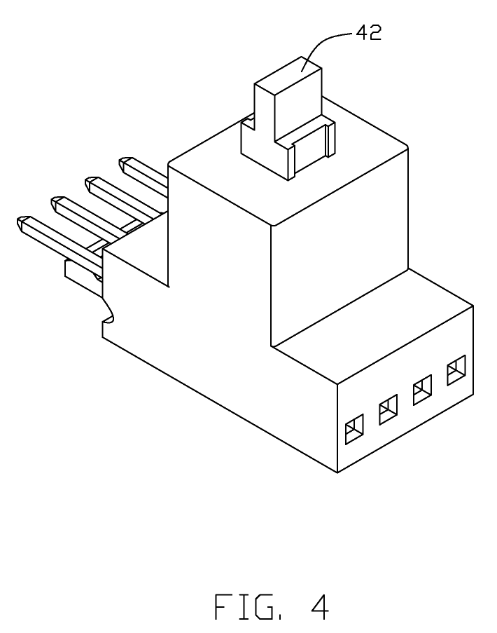

Referring also to FIG. 4, a connector adapter in accordance with a second embodiment of the present invention is shown. The second embodiment is similar to the first embodiment, except that in place of the sub-switches 12 a push-button switch 42 is provided. In this embodiment, the push-button switch 42 only controls electrical connections for four power pins and four power sockets of the connector adapter.

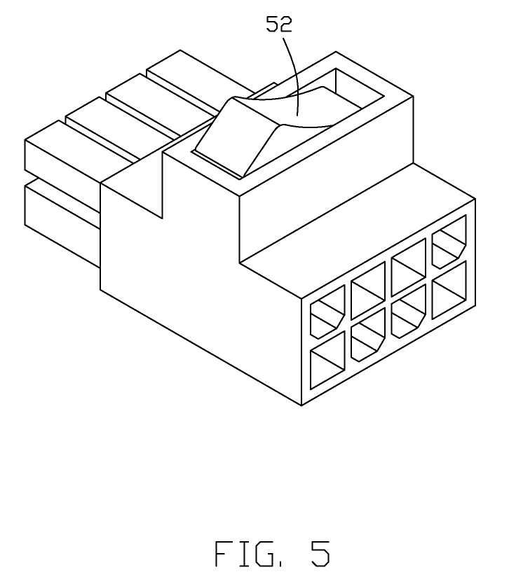

Referring also to FIG. 5, a connector adapter in accordance with a third embodiment of the present invention is shown. The third embodiment is similar to the first embodiment, except that in place of the sub-switches 12 a gang switch 52 is provided. In this embodiment, the gang switch 52 only controls electrical connections for eight power pins and eight power sockets of the connector adapter.

In the above embodiments, users can conveniently switch connections between two corresponding connectors by use of the connector adapter, thereby prolonging lifespan of the two corresponding connectors, and reduce the cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A connector adapter configured for connecting two mated connectors which are connectable with each other directly, comprising:
an integral base, a plurality of pins extending out of an end of the base configured for inserting into sockets of one of the two mated connectors respectively,
a plurality of sockets defined in an opposite end of the base corresponding to the pins configured for receiving pins of the other one of the two mated connectors respectively, and a switch exposed from at least one side surface of the base and arranged between the pins and the sockets of the connector adapter, the switch connecting the pins and the sockets of the connector adaptor, thereby controlling electrical connections between the pins and the sockets of the connector adaptor.

2. The connector adapter as claimed in claim 1, wherein the switch comprises a plurality of sub-switches corresponding to the pins and the sockets, each of the pins is connected to one corresponding socket via one corresponding sub-switch.

3. The connector adapter as claimed in claim 2, wherein each of the sub-switches is a slide switch.

4. The connector adapter as claimed in claim 1, wherein the switch is a push-button switch.

5. The connector adapter as claimed in claim 1, wherein the switch is a gang switch.

6. A connector adapter assembly comprising:
a first electronic component having a male connector;
a second electronic component having a female connector which is directly connectable to the male connector; and
a connector adapter comprising an integral base having a female end defined in an end of the base configured for connecting to the male connector, a male end extending out of an opposite end of the base configured for connecting to the female connector, and a switch exposed from at least one side surface of the base and arranged between the female end and the male end configured for controlling electronic connections between the female end and the male end.

7. (canceled)

8. The connector adapter assembly as claimed in claim 6, wherein the switch comprises a plurality of sub-switches, each of the sub-switches is connected between one pin of the female end and its corresponding socket of the female end.

9. The connector adapter assembly as claimed in claim 8, wherein each of the sub-switches is a slide switch.

10. The connector adapter assembly as claimed in claim 6, wherein the switch is a push-button switch which controls connections between at least some pins of the male end and their corresponding sockets of the female end.

11. The connector adapter assembly as claimed in claim 6, wherein the switch is a gang switch which controls connections between at least some pins of the male end and their corresponding sockets of the female end.

12. A connector adaptor assembly comprising:
a first electronic connector having a male connector;
a second electronic component having a female connector which is directly connectable to the male connector; and
a connector adaptor comprising a rectangular base comprising two opposite ends and a peripheral side connecting the two opposite ends, a plurality of pins extending from one of the ends configured to be inserted into sockets of the female connector of the second electronic component, a plurality of sockets defined in the other one of the ends configured to receive pins of the male connector of the first electronic component, the sockets of the connector adaptor being separated from the pins of the connector adaptor, a switch arranged in the middle of the base and connected between the pins and the sockets of the connector adaptor to control electronic connections therebetween, the switch exposed from the peripheral side of the base.

13. The connector adaptor assembly as claimed in claim 12, wherein the first electronic component is a printed circuit board, and the second electronic component is an external component which has the female connector and a cable.
